(19) United States
(12) Patent Application Publication
(10) Pub. No.: US 2004/0008970 A1
(43) Pub. Date: Jan. 15, 2004

(54) Enhanced bookmarks for digital video playback

(76) Inventors: Phillip Aaron Junkersfeld, Carmel, IN (US); Daniel Richard Schneidewend, Fishers, IN (US)

Correspondence Address: JOSEPH S. TRIPOLI, THOMSON MULTIMEDIA LICENSING INC., 2 INDEPENDENCE WAY, P.O. BOX 5312, PRINCETON, NJ, 08543-5312, US

(21) Appl. No.: 10/191,759

(22) Filed: Jul. 9, 2002

(51) Int. Cl. H04N 5/783; G11B 27/00

(52) U.S. Cl. 386/69; 386/70

(57) ABSTRACT

A digital video recording device and a method for book-marking any user selected location in a multimedia presentation that is recorded. The method includes the step of annotating without interruption during a playback operation of the digital recording device a user accessible mark corresponding to a user selected location appearing anywhere within a digitally recorded multimedia presentation. The method further includes the step of determining the user selected location based on the annotated mark, and selectively resuming playback of the multimedia presentation from the selected location. The annotation step can further include identifying an index value that uniquely identifies the user selected location, and storing the index value in a data store. The index value can be a time measurement, a frame identifier or a data quantity measurement. A user identification, a bookmark identification, a date or a time can be stored with the index value in the data store.

### BACKGROUND OF THE INVENTION

1. Technical Field

The present invention relates to the field of digital video recording, and more particularly to operational features in a personal video recorder.

2. Description of the Related Art

Digital video recorders allow users to view broadcast multimedia presentations on a delayed schedule, and even permit delayed viewing while the broadcast continues. After initiating recording on a storage medium, the user can begin playback of the portion of multimedia presentation just recorded. Furthermore the playback can be paused while the remainder of the broadcast presentation continues to be recorded. In addition the user can restart playback of the recording from where it was paused.

However, if multiple users are viewing a recorded presentation and one person pauses the playback, the other users are then unable to view the playback while it remains paused. This can be very inconvenient if the playback is paused for a substantial amount of time. Either the other users must wait for the pausing viewer to restart the presentation, or the other viewers can un-pause the multimedia presentation, thereby making it difficult for the pausing viewer to resume viewing without missing some of the program content.

Some digital video recorders can bookmark a program playback where the last viewer stopped the presentation. However, in these systems the bookmark is typically erased when the playback is re-commenced. Therefore, if multiple users were distracted from the original viewing of the presentation and one of the users resumes viewing, to finish the presentation without waiting for the other distracted users, the other distracted users will subsequently be unable to resume viewing from where they left off. Further, only a single bookmark can be created in present digital video recorders. Hence if multiple users cease viewing at different locations within the programming, only one of the users is able to resume the playback from the paused location. Hence, what is needed is a device that can implement multiple non-volatile digital bookmarks on a multimedia device.

### SUMMARY OF THE INVENTION

The present invention relates to a digital video recording device and a method for book-marking any user selected location in a recorded presentation.

The method includes the step of annotating, without interruption during a playback operation of the digital recording device, a user accessible mark corresponding to a user selected location within a digitally recorded multimedia presentation. The method further includes the step of determining the user selected location based on the annotated mark, and selectively resuming playback of the recording from the selected location.

The annotation step can further include identifying an index value that uniquely identifies the user selected location, and storing the index value in a data store. The index value can be a time measurement, a frame identifier or a data quantity measurement. A user identification, a bookmark identification, a date or a time can be stored with the index value in the data store.

The system for book-marking any user selected location in a multimedia presentation can include annotating means and means for determining the user selected location based on the annotated mark. The system can further include a processor, a user interface communicatively coupled to the processor, and a storage communicatively coupled to the processor.

### BRIEF DESCRIPTION OF THE DRAWINGS

FIG. 1 is a block diagram of multimedia components that implement non-volatile bookmarking in accordance with the present invention.

FIG. 2 is a flow chart showing the method of applying bookmarks within a multimedia presentation in accordance with the present invention.

FIG. 3 is a flow chart showing the method of retrieving bookmarks for selected playback of a multimedia presentation in accordance with the present invention.

### DETAILED DESCRIPTION

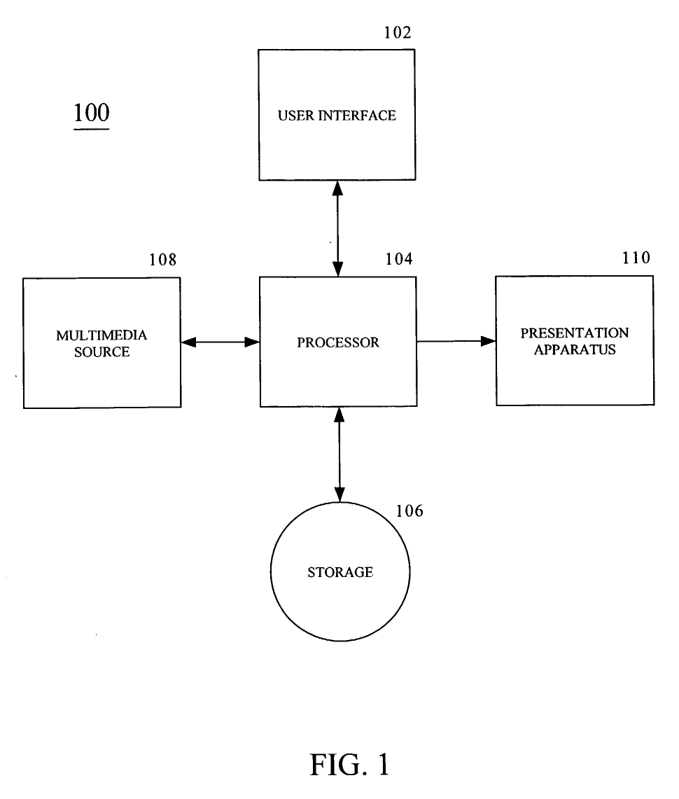

Referring to FIG. 1, a block diagram of a recording and playback device 100 that facilitates non-volatile bookmaking is shown. The recording and playback device or mutimedia device can be a digital video recorder, a personal video recorder, a digital videodisk (DVD) player, a compact disk (CD) player, or any other device that processes multimedia for presentation. As defined herein, the term multimedia can include video image representative data, audio data, graphical data or any combination thereof. A broadcast multimedia presentation is a particular multimedia presentation, for example a television program that is propagated from a source by RF or cable transmission to one or more receiver destinations. As defined herein, multimedia is descriptive of signals representative of video, audio, still and graphical images or any combination thereof.

The multimedia device 100 can include a user interface 102, which can further include a display, a remote control unit, a keypad, buttons, a touch screen, voice recognition, tactile recognition, etc. The multimedia device 100 can also include a processor 104. The processor 104 can be a multimedia processor, a microprocessor, a digital signal processor, or any other processing device. Further, the processor 104 can be a combination of processing devices which facilitate different processing tasks. For example, processor 104 can comprise microprocessor and a video processor. The multimedia device also can include storage device 106. Storage unit 106 can be a magnetic disk medium, an optical disk medium, an electronic storage medium, and/or other data storage device. For example, storage device 106 can be a hard disk drive, a rewritable optical disk, random access memory or a combination of these.

Multimedia source 108 can provide multimedia data for a multimedia presentation. For example, if the multimedia device 100 is a digital video recorder, the multimedia source 108 can be a multimedia broadcast, such as a television broadcast. In another example the multimedia device 100 can be a DVD player. The multimedia source 108 thus can be a DVD operating in a DVD playback apparatus integrated within device 100. The DVD playback apparatus can include a drive mechanism, a pickup, a control CPU, a servo control unit and navigation data generation circuitry. The DVD playback apparatus can also include other DVD player components, as would be known to one skilled in the art of DVD player design.

Presentation apparatus 110 can include a video display device, audio system, or a combination of video and audio components. The presentation apparatus 110 can be integrated into the multimedia device 100. For example, video or visual images can be displayed by a cathode ray tube display, LCD or LED display array. Audio or acoustic signals can be presented to the user by loud speaker, ear phone or other acoustic transducer providing bone conduction. Nevertheless, presentation apparatus 110 also can be external to the multimedia device 100, for example if the presentation apparatus 110 is a television or video display monitor. Each of the user interface 102, storage device 106, multimedia source 108 and presentation apparatus 110 can be communicatively coupled to processor 104.

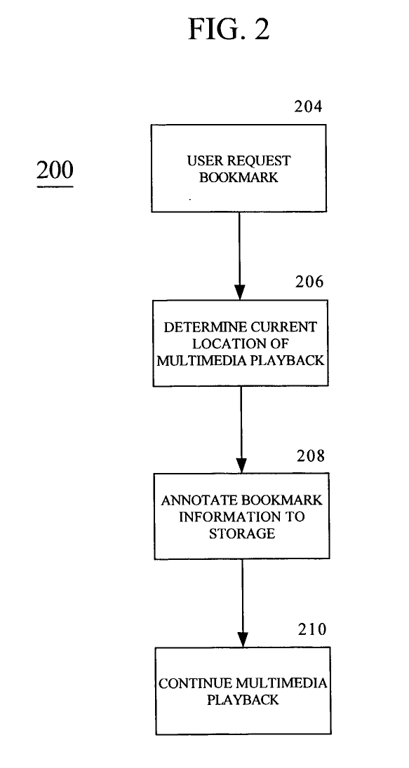

FIG. 2 is a flow chart 200 showing a method for annotating bookmarks in order to reference specific locations within a multimedia presentation. The process starts at step 202. Referring to step 204, a viewer can annotate a user accessible mark (bookmark) at the current location within the multimedia playback by means of user interface 102, which communicates the bookmark information to the processor 104. Communication between processor 104 and user interface 102 is bi-directional thereby allowing bookmark request submission to the processor and bookmark retrieval data, for example bookmark owner name to be communicated to and displayed by the user interface. The bookmark can be annotated without interruption in playback of the multimedia presentation. The bookmark can enable the user to re-start a playback of the recorded multimedia presentation at some later time from the location identified by the bookmark. If other users desire to annotate bookmarks in the multimedia presentation, they can do so as well. As used herein, the term “annotate” means storing relevant information, for example, a location in a presentation to be bookmarked, a bookmark identifier, for example user name, and/or comments about the bookmark. Thus bookmarks can enable user annotation for subsequent replay and review without interruption to other users viewing and advantageously bookmaking their own individual review locations within the program presentation.

Referring to step 206, when the processor 104 receives a bookmark request the processor can determine the current location of playback in the multimedia presentation. In one arrangement the processor can communicate with the storage 106 to determine the current multimedia playback location. This arrangement is particularly useful if the multimedia device 100 is a personal video recorder and a multimedia presentation is played from multimedia data recorded on the storage 106. In another arrangement the processor can determine the current multimedia playback location directly from the multimedia source 108. For example, the multimedia device 100 can be a CD or DVD player and the multimedia presentation can be played directly from a CD or DVD. In an alternate embodiment, the user can specify a particular location in the multimedia presentation to be bookmarked.

Multimedia playback location information can be determined by an index value. The index value can be a time measurement, a frame identifier, a data quantity measurement, or any other method of identifying a location in a multimedia presentation. For example, in the case the storage unit 106 is a hard disk drive and the multimedia presentation is stored as MPEG data, the bookmark can be the current disk storage sector or a byte offset from the start of the file, and a presentation time stamp (PTS) of a bookmarked frame of video. The storage sector or byte offset can be used to tell the hard disk drive where to start reading the data, and the PTS can be used to tell the processor 104 exactly which frame to resume with. To select the desired bookmark from a list of available bookmarks, the user may be presented with a series of still pictures, thumbnails or minified pictures representing the video frame marked by the bookmark.

After the multimedia playback current location is determined, the bookmark information can be stored or annotated at step 208. The bookmark information preferably includes at least the current program location data determined in step 206 and a bookmark identification. The bookmark identification is preferably any type of information that can be used to allow a user to readily identify a previously established bookmark. For example, a reference number or alpha numeric identifier can be used for this purpose. The bookmark can be stored on the same medium as a multimedia programming when reproduced from a recordable medium, or in a separate storage location when the program source is non-recordable, such as a DVD. Further, additional information can be stored with the current program location data. For example, user name or identification, date, time and additional program information can be stored with the multimedia location data. All of the data stored in response to a bookmark request can be collectively referred to as a bookmark.

A plurality of bookmarks can be written to storage 106. When a new bookmark is created, it can be uniquely identified so that it is differentiated from other bookmarks and in addition is readily identifiable by a plurality of individual users. Either the user can name a bookmark or the bookmark can be given a default identification, for example a sequential number, date and time, name of show or movie, name of the user, or any combination of the above. In one arrangement the bookmarks can remain within storage 106 until deleted by a user. In this way an exemplary DVD can be temporarily removed from player 100 with the stored bookmarks being re-associated with the specific DVD when reinserted. In another arrangement bookmarks can be removed when the multimedia presentation that they refer to are removed from storage 106.

Referring to step 210, playback continues during bookmaking or annotation. Thus playback can continue throughout the bookmarking process without interruption to the multimedia presentation. In another embodiment, the user can be given an option to pause the multimedia presentation during annotation, for example to allow playback image scrutiny and or image titling or description.

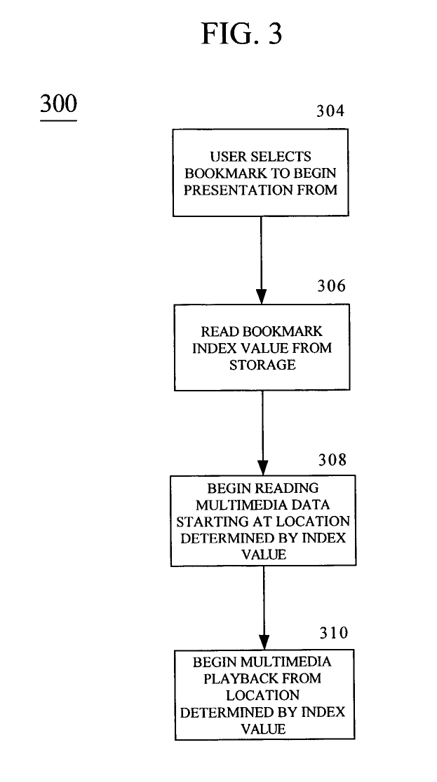

FIG. 3 is a flow chart showing the method of resuming playback from a bookmarked location within a multimedia presentation. The process begins at step 302. Referring to step 304, a user can select a bookmark identifying a location from which the playback will be initiated. In one arrangement, a menu of bookmark selections can be presented to the user via the user interface 102, for example a user may be presented with a displayed menu of still pictures or thumbnails that represent individual frames of video images marked or annotated by bookmarks. In a further arrangement a selection of bookmarks with, for example user's identification, thumbnail image, and description can be presented for user selection via presentation apparatus 110 by use of an on screen display capability. The user can select a specific bookmark from the menu using the user interface 102, for example with a remote control which permits a cursor to be scrolled or a specific bookmark selected, with the selection forwarded to processor 104. Referring to step 306, the index value contained in or referring to the selected bookmark can be read from storage 106 and communicated to processor 104.

Playback of the multimedia programming data is initiated from the location identified by the index value, as shown in step 308, and the multimedia program data can be forwarded to the presentation apparatus 110 for presentation or visual display to the user. If storage 106 contains a recording of the multimedia presentation then the multimedia presentation data can be read from storage 106, for example if the multimedia device is a personal video recorder. If the multimedia source 108 contains a recording of the multimedia presentation, for example a DVD player, then the multimedia presentation data can be read from the multimedia source 108. The multimedia presentation can continue until the presentation is complete, as shown in step 310. Alternatively, the user can create another bookmark if it is desired to stop the presentation and finishing viewing it at a different time, or if the user wishes to return to a specific portion of the presentation at a later time.

It should be understood that the examples and embodiments described herein are for illustrative purposes only and that various modifications or changes in light thereof can be suggested by persons skilled in the art and are to be included within the spirit and purview of this application. The invention can take many other specific forms without departing from the spirit or essential attributes thereof for an indication of the scope of the invention.

What is claimed is:

1. In a digital video recording and playback device, a method for book-marking a location during playback, comprising the steps of:
annotating without playback interruption a user selected location within a digitally recorded presentation; and,
initiating playback of said digitally recorded presentation from said annotated mark responsive to user input.

2. The method according to claim 1 wherein said annotating step further comprises;
identifying an index value that identifies said user selected location; and,
storing said index value in a data store.

3. The method according to claim 2 wherein said storing step comprises
selecting at least one datum from a group including user identification, a bookmark identification, a date and a time and,
storing said at least one datum with said index value in said data store.

4. The method according to claim 2 wherein said identifying step includes selecting said index value from a group consisting of a time measurement, a frame identifier and a data quantity measurement.

5. In a digital video recording device a system for book-marking any user selected location in a multimedia presentation that is recorded, comprising:
annotating means for annotating without interruption during a playback operation of said digital video recorder a user accessible mark corresponding to a user selected location within a digitally recorded multimedia presentation; and
means responsive to a user input, for determining said user selected location in accordance with said annotated mark, and selectively initiating playback of said multimedia presentation from said user selected location.

6. In a multimedia playback device, a method for book-marking a user selected location within a multimedia playback presentation, comprising:
annotating without playback interruption a user mark defining a location selected within said multimedia playback presentation; and,
initiating playback of said multimedia presentation from said user defined location responsive to user input.

7. The method according to claim 6 wherein said annotation step comprises
identifying an index value that uniquely identifies said user selected location, and
storing said index value in a data store.

8. The method according to claim 7 wherein said storing step comprises;
selecting at least one datum from a group including a user identification, a bookmark identification, a date and a time is stored in said data store.

9. The method according to claim 6 wherein said identifying step includes;
selecting from a group comprising a time measurement, a frame identifier and a data quantity measurement.

10. The method according to claim 6 wherein said annotating step includes;
saving said user mark in a data store when said multimedia presentation is played from a DVD.

11. In a multimedia device a system for book-marking a user selected location within a digitally recorded multimedia presentation, comprising:
annotating means for annotating a user accessible mark corresponding to a location within said digitally recorded multimedia presentation; and,
means responsive to a user input, for finding said location in accordance with said annotated mark, and selectively initiating playback of said multimedia presentation from said location.

12. The system according to claim 11, further comprising:
a user interface for initiating one of annotating and retrieving data corresponding to said location;
a memory for storing and retrieving an annotation corresponding to said Location;
a processor bidirectionally coupled to said user interface and said memory, for controllably annotating said location data and storing in said memory and, for controllably retrieving said annotation from said memory and coupling said annotation to said user interface.
